(19) United States
(12) Patent Application Publication
(10) Pub. No.: US 2014/0041754 A1
(43) Pub. Date: Feb. 13, 2014

(54) GAS FILLING DEVICE OF WAFER CARRIER WITH FUNCTION OF MONITORING GAS PROPERTY AT GAS DISCHARGE END

(71) Applicant: CHUAN-HUA CHOU, Hsinchu City (TW)

(72) Inventor: CHUAN-HUA CHOU, Hsinchu City (TW)

(73) Assignee: SANTA PHOENIX TECHNOLOGY INC., Hsinchu City (TW)

(21) Appl. No.: 13/584,430

(22) Filed: Aug. 13, 2012

(51) Int. Cl. F17D 1/02

(52) U.S. Cl. 141/83

(57) ABSTRACT

A gas filling device of wafer carrier with a function of monitoring gas property at gas discharge end includes a mass flow controller, a gas intake end coupled to the mass flow controller, a gas discharge end, a gas collection box coupled to the gas discharge end, and a gas property measuring device coupled to the gas collection box. When use, the gas intake end and the gas discharge end are coupled to a wafer carrier, and the mass flow controller controls a gas to fill from the gas intake end into the wafer carrier, and an exhaust gas is discharged from the gas discharge end, after a numeric value of a gas property of the gas discharged from the wafer carrier is measured by the gas property measuring device.

### FIELD OF THE INVENTION

The present invention relates to a gas filling device of a wafer carrier with a function of monitoring a gas property at a gas discharge end, in particular to the gas filling device of a wafer carrier that can monitor a gas property at the gas discharge end by installing a gas property measuring device at the gas discharge end to measure the gas property of the gas discharged from the wafer carrier during a gas filling process.

### BACKGROUND OF THE INVENTION

Oxygen has strong chemical activity and reacts with other substances easily to form oxides, and thus the yield rate of products may be affected adversely to cause a serious loss in production capacity. Therefore, the manufacturing process of some precision industries such as chemical engineering, electronics, semiconductor, and optoelectronics requires nitrogen of a high purity for nitrogen seal to maintain the system in an oxygen-free operating environment.

Nitrogen gas or clean dry air (CDA) or extreme clean dry air (XCDA) is generally filled into a conventional wafer carrier through a gas filling device of the wafer carrier to achieve the effect of eliminating oxygen and moisture, so as to prevent the oxygen and moisture from chemically reacting with wafers in the wafer carrier to form oxides on a wafer surface or reduce the yield rate of the manufacturing process. However, each wafer carrier has a different air-tightness, and the gas filling device of a wafer carrier may have a loss of gas flow due to a component failure, so that it is necessary to control the oxygen and moisture in the wafer carrier and obtain information and data with regard to the reduction or elimination of oxygen and moisture in the wafer carrier.

With reference to FIG. 1 for a schematic view of a conventional gas filling device of a wafer carrier, the conventional gas filling device comprises a mass flow controller 11, a gas intake end 12, a handheld moisture meter 13, a gas discharge end 14 and a wafer carrier 15. The conventional gas filling device of a wafer carrier is controlled by the mass flow controller 11, and nitrogen gas is filled from the gas intake end 12 into the wafer carrier 15 and an exhaust gas is discharged from the gas discharge end 14. In the conventional gas filling device of a wafer carrier, a handheld moisture meter 13 or a handheld oxygen concentration detector is put into in wafer carrier 15 to detect a change of performance of eliminating moisture or oxygen inside the wafer carrier 15.

With reference to FIG. 2 for a schematic block diagram of a conventional gas filling device of a wafer carrier pipeline, the gas filling device comprises a mass flow controller 11, a gas discharge end 14, a nitrogen gas 21, a filter 22, 26, 27, a solenoid valve 23, 24, 25, a first type wafer carrier 28, a second type wafer carrier 29 and an exhaust gas solenoid valve 210. After a nitrogen gas source inputs the nitrogen gas 21 into the conventional gas filling device of a wafer carrier, the nitrogen gas 21 is filtered by the filter 22, and the mass and flow of the filling gas are controlled and adjusted by the mass flow controller 11. Before the gas is filled into the wafer carrier, unwanted gases are filtered by the filters 26 and 27 to cope with different types of wafer carriers 28 and 29, and the gas is filled into the corresponding first type wafer carrier 28 and second type wafer carrier 29. The gas discharge end 14 is coupled to the wafer carriers 28 and 29 for eliminating the exhaust gas discharged from the wafer carriers 28 and 29. In addition, a plurality of solenoid valves 23, 24, 25, 210 is installed in a pipeline for controlling the gas flow condition at each stage of the pipeline.

However, the aforementioned conventional gas filling device of a wafer carrier does not come with the function of monitoring a gas property such as the oxygen content or moisture, so that a handheld oxygen concentration detector or a moisture meter is placed inside the wafer carrier to detect the gas filling performance of the gas filling device manually. The conventional gas filling device of a wafer carrier cannot feed back a gas property immediately and linearly and thus cannot provide an effective monitoring mechanism.

The conventional gas filling device of a wafer carrier has the following drawbacks:

1. The conventional gas filling device does not have the function of monitoring a gas property such as the oxygen content or moisture.

2. The conventional gas filling device detects the gas filling performance manually, and thus failing to feed back the measurement results immediately and linearly or provide an effective monitoring mechanism.

3. The conventional gas filling device checks the gas filling performance manually, and thus requiring additional human resources for periodical inspections.

Therefore, it is a main subject of the present invention to overcome the aforementioned drawbacks of the prior art by providing a gas filling device of a wafer carrier with the function of monitoring a gas property.

### SUMMARY OF THE INVENTION

It is a primary objective of the present invention to provide a gas filling device of a wafer carrier with the function of monitoring a gas property at a gas discharge end, wherein the gas filling device has a set of a gas collection box and a gas property measuring device installed at a gas discharge end, and the property of the gas moisture which does not vary with the flow is adopted, and the gas discharged from the wafer carrier is collected into the gas collection box, and a gas property measuring device with a digital signal feedback function is provided for a measurement, and the data are transmitted back to a control computer of the gas filling device of a wafer carrier for a comparison, so as to achieve the effect of monitoring a gas property of a gas inside the wafer carrier, when the gas is filled.

To achieve the aforementioned and other objectives, the present invention provides a gas filling device of a wafer carrier with a function of monitoring gas property at gas discharge end, comprising: a mass flow controller; a gas intake end, coupled to the mass flow controller; a gas discharge end; a gas collection box, coupled to the gas discharge end; and a gas property measuring device, coupled to the gas collection box; thereby, in an application, the gas intake end and the gas discharge end are coupled to a wafer carrier, and a gas is filled from the gas intake end to a the wafer carrier through a control of the mass flow controller; and after a numeric value of a gas property of the gas discharged from the wafer carrier is measured is measured by the gas property measuring device, the gas is discharged from the gas discharge end.

In the aforementioned gas filling device of a wafer carrier with the function of monitoring a gas property at a gas discharge end, the gas collection box is coupled between the gas discharge end and the gas property measuring device for collecting the gas discharged from the wafer carrier, and providing the gas for the gas property measuring device to measure.

In the aforementioned gas filling device of a wafer carrier with the function of monitoring a gas property at a gas discharge end, the gas is nitrogen gas or clean dry air.

In the aforementioned gas filling device of wafer carrier with the function of monitoring a gas property at a gas discharge end, the gas property is temperature, moisture, pressure, oxygen concentration or another specific gas concentration.

In the aforementioned gas filling device of a wafer carrier with the function of monitoring a gas property at a gas discharge end, the gas property measuring device is a digital moisture meter or an oxygen concentration detector.

### BRIEF DESCRIPTION OF THE DRAWINGS

FIG. 1 is a schematic view of a conventional gas filling device of a wafer carrier;

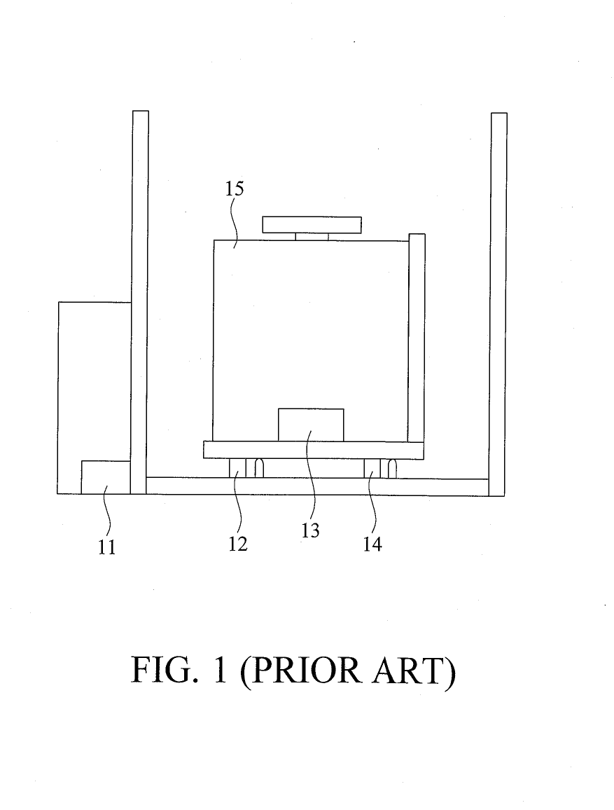

FIG. 2 is a schematic block diagram of a conventional gas filling device of a wafer carrier pipeline;

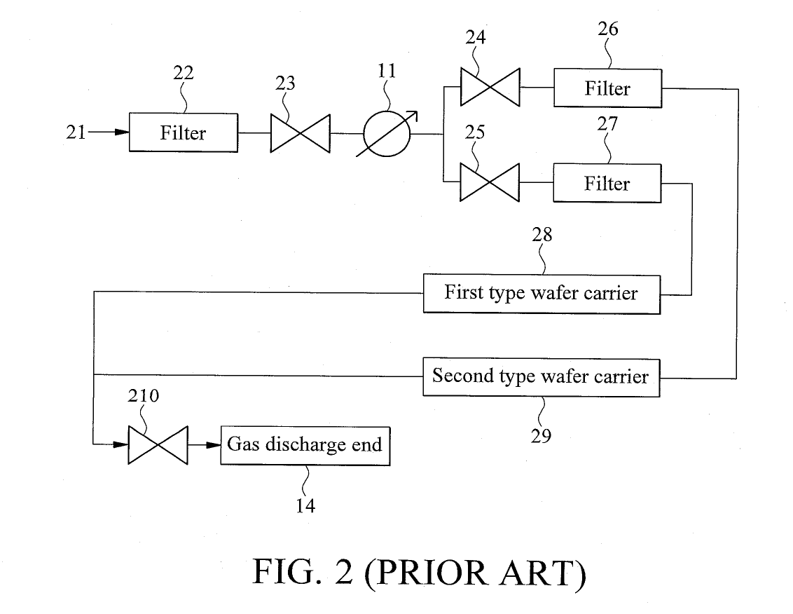

FIG. 3 is a schematic view of a gas filling device of a wafer carrier with a function of monitoring gas property at a gas discharge end in accordance with a preferred embodiment of the present invention; and

FIG. 4 is a schematic block diagram of a gas filling device of a wafer carrier with a function of monitoring gas property at a gas discharge end in accordance with a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

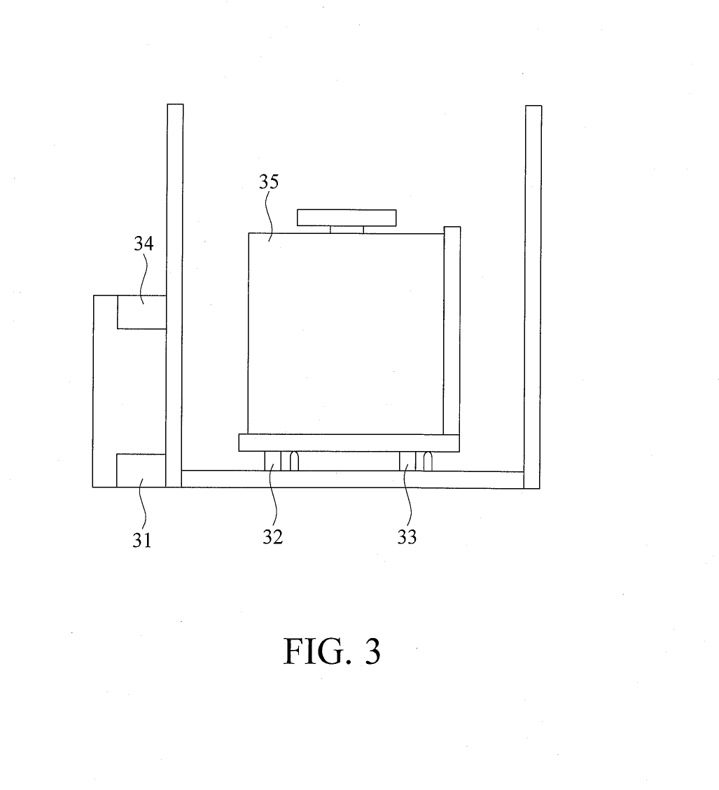

With reference to FIG. 3 for a schematic view of a gas filling device of a wafer carrier with a function of monitoring gas property at a gas discharge end in accordance with a preferred embodiment of the present invention, the gas filling device comprises a mass flow controller 31, a gas intake end 32, a gas discharge end 33, a gas property measuring device 34 and a wafer carrier 35. The gas intake end 32 is coupled to the mass flow controller 31 and the wafer carrier 35, and the mass and flow of a desired filling gas such as nitrogen gas or clean dry air is controlled by the mass flow controller 31 and filled from the gas intake end 32 into the wafer carrier 35. The gas discharge end 33 is coupled to the gas property measuring device 34 and the wafer carrier 35 for discharging exhaust gas from the wafer carrier 35 through the gas discharge end 33 after the gas property measuring device 34 measures the numeric value of a gas property.

Wherein, the gas property is temperature, moisture, pressure, oxygen concentration or another specific gas concentration; and the gas property measuring device 34 is a digital moisture meter or an oxygen concentration detector, and the gas property measuring device 34 with a digital signal feedback function is provided for measuring the gas property, and the measured data are transmitted immediately back a control computer of the gas filling device of a wafer carrier for an immediate comparison to monitor and control the change of the gas property inside the wafer carrier.

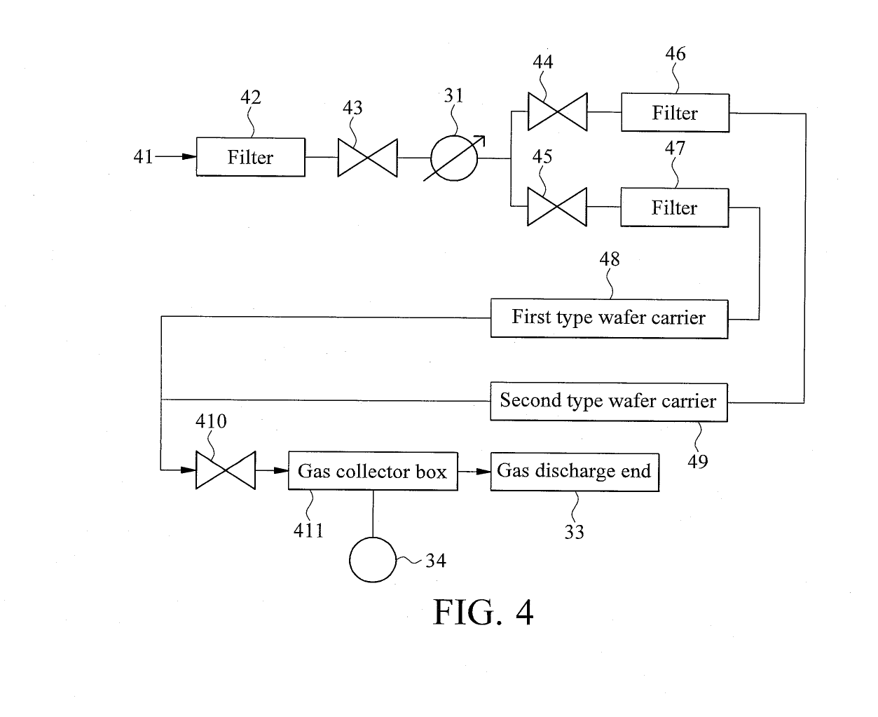

With reference to FIG. 4 for a schematic block diagram of a gas filling device of a wafer carrier with a function of monitoring gas property at a gas discharge end in accordance with a preferred embodiment of the present invention, the gas filling device comprises a mass flow controller 31, a gas discharge end 33, a gas property measuring device 34, a nitrogen gas 41, a filter 42, 46, 47, a solenoid valve 43, 44, 45, a first type wafer carrier 48, a second type wafer carrier 49, an exhaust gas solenoid valve 410 and a gas collection box 411. Similar to the prior art, after a nitrogen gas source inputs the nitrogen gas 41 to the gas filling device of a wafer carrier of the present invention, the nitrogen gas 41 is filtered by the filter 42, and then the mass flow controller 31 controls and adjusts the mass and flow of the desired filling gas. Before the gas is filled into the wafer carrier, unwanted gases are filtered by the filters 46 and 47 to cope with different types of wafer carriers 48 and 49, and the filtered gas is filled into the corresponding first type wafer carrier 48 and second type wafer carrier 49. Unlike the prior art, the gas property measuring device 34 and the gas collection box 411 are disposed at the gas discharge end 33 of the present invention, wherein the gas collection box 11 is provided for collecting the gas discharged from the wafer carriers 48 and 49, and the gas property measuring device 34 is provided for measuring a gas property of the gas, and finally the exhaust gas is discharged from the gas discharge end 33. In addition, a plurality of solenoid valves 43, 44, 45, 410 is installed in a pipeline for controlling the gas flow condition at each stage of the pipeline.

The gas filling device of a wafer carrier with the function of monitoring a gas property at a gas discharge end of the present invention has the following advantages:

1. The gas filling device can monitor and control a gas property.

2. The gas filling device can feed back measurement results immediately and linearly to provide an effective monitoring mechanism.

3. The gas filling device performs the measurement automatically without requiring additional human resources for the inspection.

In summation of the description above, the gas filling device of a wafer carrier with the function of monitoring a gas property at a gas discharge end in accordance with the present invention not only has the function of monitoring the gas property, but also feeds back the measurement results immediately and linearly by an automated method. If it is necessary to change the design, such as adopting a different type of the gas property measuring device, measuring the numeric values of different types of gas properties or transmitting the measurement results to different types of control systems, the corresponding type of the gas property measuring device is installed at the gas discharge end of the gas filling device of the wafer carrier. Obviously, the present invention improves over the prior art and complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A gas filling device of a wafer carrier with a function of monitoring a gas property at a gas discharge end, comprising:
a mass flow controller;
a gas intake end, coupled to the mass flow controller;
a gas discharge end;
a gas collection box, coupled to the gas discharge end; and
a gas property measuring device, coupled to the gas collection box;
thereby, in an application, the gas intake end and the gas discharge end are coupled to a wafer carrier, and a gas is filled from the gas intake end to a the wafer carrier through a control of the mass flow controller; and after a numeric value of a gas property of the gas discharged from the wafer carrier is measured is measured by the gas property measuring device, the gas is discharged from the gas discharge end.

2. The gas filling device of claim 1, wherein the gas collection box is coupled between the gas discharge end and the gas property measuring device for collecting the gas discharged from the wafer carrier, and providing the gas for the gas property measuring device to measure.

3. The gas filling device of claim 1, wherein the gas is nitrogen gas or clean dry air.

4. The gas filling device of claim 1, wherein the gas property is one selected from the collection of temperature, moisture, pressure, oxygen concentration and another specific gas concentration.

5. The gas filling device of claim 1, wherein the gas property measuring device is a digital moisture meter or an oxygen concentration detector.
